(19) United States
(12) Patent Application Publication
(10) Pub. No.: US 2023/0231776 A1
(43) Pub. Date: Jul. 20, 2023

(54) CONVERSATIONAL ASSISTANT DIALOG DESIGN

(71) Applicant: Juniper Networks, Inc., Sunnyvale, CA (US)

(72) Inventors: Jisheng Wang, Palo Alto, CA (US); Xiaoying Wu, Sunnyvale, CA (US); Amin Toghi Eshghi, San Carlos, CA (US); Prathamesh Dnyanesh Kumkar, Cupertino, CA (US)

(21) Appl. No.: 18/057,019

(22) Filed: Nov. 18, 2022

Related U.S. Application Data
(60) Provisional application No. 63/299,733, filed on Jan. 14, 2022.

(51) Int. Cl. H04L 41/22

(52) U.S. Cl. CPC H04L 41/22

(57) ABSTRACT

A network management system (NMS) comprises one or more processors coupled to memory. The one or more processors of are configured to determine a list of network devices from the plurality of network devices based on an entity type and determine a suggested filter attribute based on the list of network devices and one or more of a user profile, a current state of the plurality of network devices, or a current state of the networking services. The one or more processors are further configured to output, in a user interface, an indication of the suggested filter attribute and, in response to receiving user input representative of a selection of the indication of the suggested filter attribute, determine a filtered list of network devices from the list of network devices using the suggested filter attribute and output, in the user interface, an indication of the filtered list of network devices.

This application claims the benefit of U.S. Provisional Pat. Application No. 63/299,733, filed 14 Jan. 2022, the entire contents of which is incorporated herein by reference.

### TECHNICAL FIELD

The disclosure relates generally to computer networks and, more specifically, to monitoring and troubleshooting computer networks.

### BACKGROUND

Commercial premises or sites, such as offices, hospitals, airports, stadiums, or retail outlets, often install complex wireless network systems, including a network of wireless access points (APs), throughout the premises to provide wireless network services to one or more wireless client devices (or simply, “clients”). APs are physical, electronic devices that enable other devices to wirelessly connect to a wired network using various wireless networking protocols and technologies, such as wireless local area networking protocols conforming to one or more of the IEEE 802.11 standards (i.e., “Wi-Fi”), Bluetooth / Bluetooth Low Energy (BLE), mesh networking protocols such as ZigBee or other wireless networking technologies. Many different types of wireless client devices, such as laptop computers, smartphones, tablets, wearable devices, appliances, and Internet of Things (IoT) devices, incorporate wireless communication technology and can be configured to connect to wireless access points when the device is in range of a compatible wireless access point in order to access a wired network. In the case of a client device running a cloud-based application, such as voice over Internet Protocol (VOIP) applications, streaming video applications, gaming applications, or video conference applications, data is exchanged during an application session from the client device through one or more APs and one or more wired network devices, e.g., switches, routers, and/or gateway devices, to reach the cloud-based application server.

### SUMMARY

In general, this disclosure describes one or more techniques for a network management system (NMS) to provide a suggested filter attribute for selection by an administrator or other user for reducing or narrowing down a number of entities (e.g., access points, client devices, switching devices, or gateway devices) identified in response to a query from the administrator for purposes of entity search and/or troubleshooting. For example, an administrator may query for client devices that are accessing or otherwise using a particular software application. In this example, rather than outputting a large number of client devices that fulfill the initial query for review and manual filtering by the administrator, the NMS may suggest a filter attribute to filter the client devices according to some additional criteria, for example, by site. In this way, the NMS may reduce or narrow down a list of network devices responsive to the administrator’s query, which may reduce an amount of time the administrator spends to identify one or more network devices and/or troubleshoot an issue associated with one or more network devices.

In accordance with the disclosed techniques, for an access point entity type example, the NMS may determine a suggested filter attribute. For example, the NMS may determine a list of network devices that includes all access points. In this example, the NMS may determine the suggested filter attribute based on a user profile and the list of network devices. For instance, the NMS may determine a suggested filter attribute that filters the access points in the list of network devices by one or more sites associated with a user profile managed by the administrator. The NMS may determine the suggested filter attribute based on a current state of the plurality of network devices. For example, the NMS may determine a suggested filter attribute that filters the access points in the list of network devices by one or more operating systems specified in the current state of the plurality of network devices. The NMS may determine the suggested filter attribute based on a current state of networking services. For example, the NMS may determine a suggested filter attribute that filters the access points in the list of network devices to show only access points experiencing network issues associated with a Wi-Fi service specified in the current state of the networking services.

The disclosed techniques enable improved entity search and/or troubleshooting by suggesting filter attribute(s) that may be intuitive to the administrator for helping to filter or further filter the list of devices, which may help to reduce an amount of time a network issue occurs and/or reduce an amount of time an administrator spends troubleshooting a network. For example, rather than relying solely on the administrator to provide filters to identify network devices for troubleshooting, the NMS may prompt a user to select a filter attribute (e.g., a particular site from a filter attribute suggesting to filter by sites). In response to user input selecting the the filter attribute, the NMS may further generate a filtered list of network devices and output an indication of the a filtered list of network devices to a troubleshooting user interface for review by the administrator.

In one example, a network management system (NMS) that manages a plurality of network devices configured to provide networking services at a plurality of sites, the NMS includes a memory storing a current state of the plurality of network devices and one or more processors coupled to the memory. The one or more processors are configured to determine a list of network devices from the plurality of network devices based on an entity type and determine a suggested filter attribute based on the list of network devices and one or more of a user profile, the current state of the plurality of network devices, or a current state of the networking services. The one or more processors are further configured to output, in a user interface, an indication of the suggested filter attribute and, in response to receiving user input representative of a selection of the indication of the suggested filter attribute, determine a filtered list of network devices from the list of network devices using the suggested filter attribute and output, in the user interface, an indication of the filtered list of network devices.

In another example, a method for managing a plurality of network devices configured to provide networking services at a plurality of sites includes determining, by one or more processors, a list of network devices from the plurality of network devices based on an entity type and determining, by the one or more processors, a suggested filter attribute based on the list of network devices and one or more of a user profile, the current state of the plurality of network devices, or a current state of the networking services. The method further includes outputting, by the one or more processors, in a user interface, an indication of the suggested filter attribute and, in response to receiving user input representative of a selection of the indication of the suggested filter attribute, determining, by the one or more processors, a filtered list of network devices from the list of network devices using the suggested filter attribute and output, in the user interface, an indication of the filtered list of network devices.

In one example, a computer-readable storage medium includes instructions that, when executed, cause one or more processors of a network management system to determine a list of network devices from a plurality of network devices based on an entity type and determine a suggested filter attribute based on the list of network devices and one or more of a user profile, the current state of the plurality of network devices, or a current state of networking services provided by the plurality of network devices. The instructions further cause the one or more processors to output, in a user interface, an indication of the suggested filter attribute and, in response to receiving user input representative of a selection of the indication of the suggested filter attribute, determine a filtered list of network devices from the list of network devices using the suggested filter attribute and output, in the user interface, an indication of the filtered list of network devices

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1A is a block diagram of an example network system in which a network management system suggests a filter attribute, in accordance with one or more techniques of the disclosure.

FIG. 1B is a block diagram illustrating further example details of the network system of FIG. 1A.

FIG. 2 is a block diagram of an example access point device, in accordance with one or more techniques of this disclosure.

FIG. 3 is a block diagram of an example network management system configured to suggest a filter attribute, in accordance with one or more techniques of the disclosure.

FIG. 4 is a block diagram of an example user equipment device, in accordance with one or more techniques of this disclosure.

FIG. 5 is a block diagram of an example network node, such as a router or switch, in accordance with one or more techniques of this disclosure.

FIG. 6 illustrates a conceptual diagram of an example user interface of the network management system for visualization of a suggested first filter attribute, in accordance with one or more techniques of this disclosure.

FIG. 7 illustrates a flow chart of an example process for suggesting a filter attribute, in accordance with one or more techniques of this disclosure.

FIG. 8 illustrates a conceptual diagram of an example user interfaces of the network management system for visualization of a suggested second filter attribute, in accordance with one or more techniques of this disclosure.

FIG. 9 is a flow chart illustrating an example operation of suggesting a filter attribute, in accordance with one or more techniques of the disclosure.

FIGS. 10A-10C is a flow chart illustrating an example workflow for suggesting a filter attribute, in accordance with one or more techniques of the disclosure.

### DETAILED DESCRIPTION

Some solutions to dialog design for network administration include showing all network devices for an entity type (e.g., an application, a client, or a network device, such as an access point (AP), switch, or gateway) and relying on the administrator or other user to manually identify a filter to reduce the list of devices for the entity type. This may lead to the list of devices being a burden to search and/or may result in the administrator spending time to manually identify a filter attribute to reduce the number of devices in the list. For example, an administrator may review a list of devices and/or manually identify filter attributes to reduce the number of devices to review. Techniques described herein include, in response to a user query to either troubleshoot or identify particular entities, generation of one or more suggested filter attributes for further reducing a resulting number of devices for an entity type.

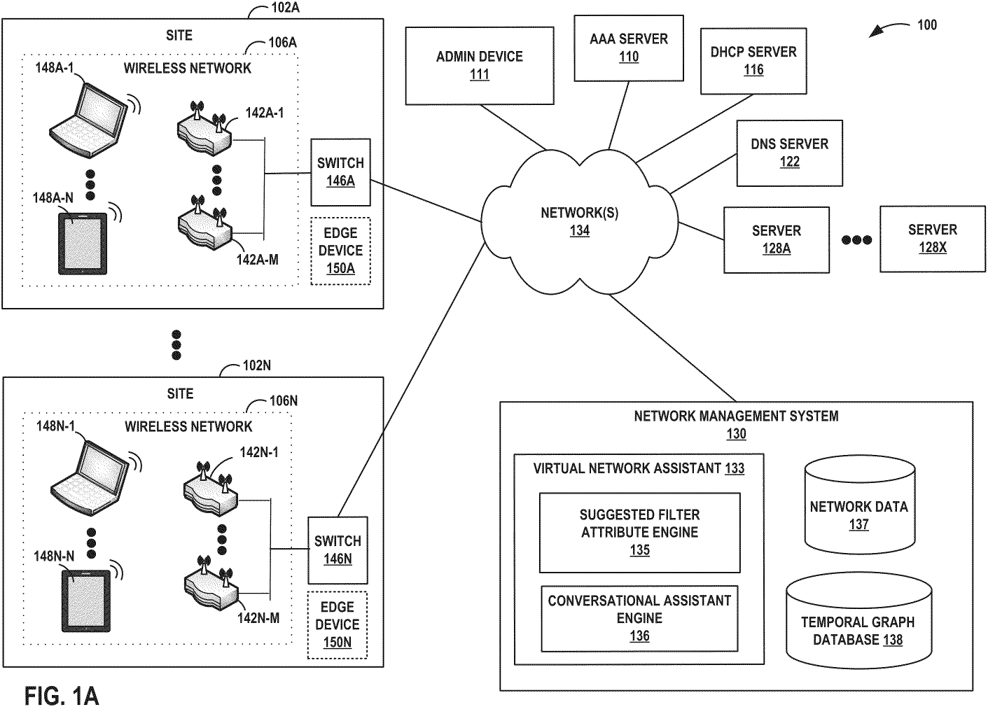

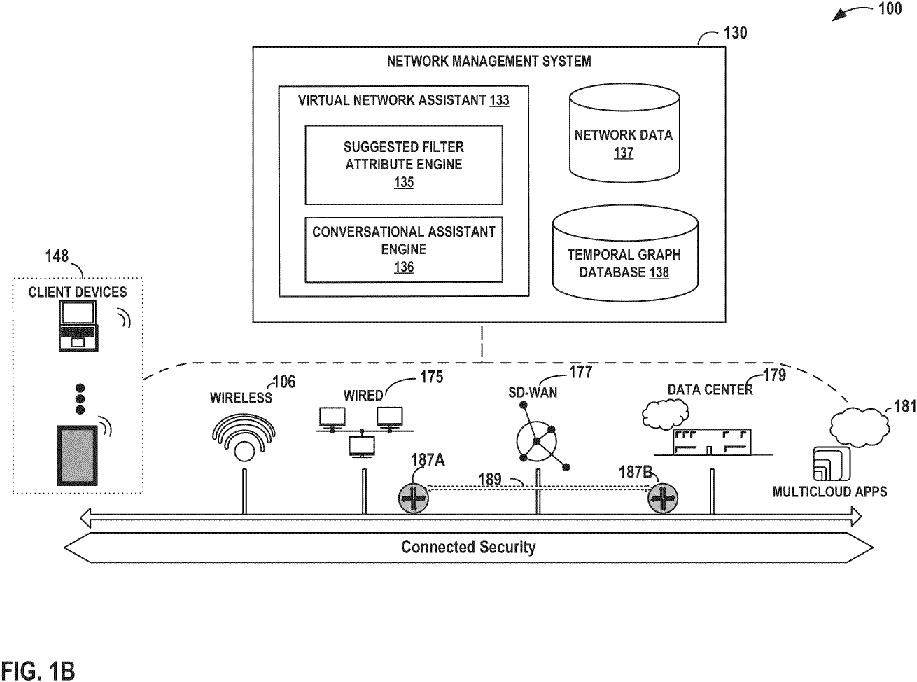

FIG. 1A is a block diagram of an example network system 100 in which a network management system (NMS) 130 may suggest a filter attribute, in accordance with one or more techniques of this disclosure. Example network system 100 includes a plurality sites 102A-102N at which a network service provider manages one or more wireless networks 106A-106N, respectively. Although in FIG. 1A each site 102A-102N is shown as including a single wireless network 106A-106N, respectively, in some examples, each site 102A-102N may include multiple wireless networks, and the disclosure is not limited in this respect.

Each site 102A-102N includes a plurality of network access server (NAS) devices, such as access points (APs) 142, switches 146, or routers (not shown) within the wired network edge. For example, site 102A includes a plurality of APs 142A-1 through 142A-M. Similarly, site 102N includes a plurality of APs 142N-1 through 142N-M. Each AP 142 may be any type of wireless access point, including, but not limited to, a commercial or enterprise AP, a router, or any other device that is connected to the wired network and is capable of providing wireless network access to client devices within the site.

Each site 102A-102N also includes a plurality of client devices, otherwise known as user equipment devices (UEs), referred to generally as UEs or client devices 148, representing various wireless-enabled devices within each site. For example, a plurality of UEs 148A-1 through 148A-N are currently located at site 102A. Similarly, a plurality of UEs 148N-1 through 148N-N are currently located at site 102N. Each UE 148 may be any type of wireless client device, including, but not limited to, a mobile device such as a smart phone, tablet or laptop computer, a personal digital assistant (PDA), a wireless terminal, a smart watch, smart ring, or other wearable device. UEs 148 may also include wired client-side devices, e.g., IoT devices such as printers, security devices, environmental sensors, or any other device connected to the wired network and configured to communicate over one or more wireless networks 106.

In order to provide wireless network services to UEs 148 and/or communicate over the wireless networks 106, APs 142 and the other wired client-side devices at sites 102 are connected, either directly or indirectly, to one or more network devices (e.g., switches, routers, or the like) via physical cables, e.g., Ethernet cables. In the example of FIG. 1A, site 102A includes a switch 146A to which each of APs 142A-1 through 142A-M at site 102A are connected. Similarly, site 102N includes a switch 146N to which each of APs 142N-1 through 142N-M at site 102N are connected. Although illustrated in FIG. 1A as if each site 102 includes a single switch 146 and all APs 142 of the given site 102 are connected to the single switch 146, in other examples, each site 102 may include more or fewer switches and/or routers. In addition, the APs and the other wired client-side devices of the given site may be connected to two or more switches and/or routers. In addition, two or more switches at a site may be connected to each other and/or connected to two or more routers, e.g., via a mesh or partial mesh topology in a hub-and-spoke architecture. In some examples, interconnected switches and routers comprise wired local area networks (LANs) at sites 102 hosting wireless networks 106.

Example network system 100 also includes various networking components for providing networking services within the wired network including, as examples, an Authentication, Authorization and Accounting (AAA) server 110 for authenticating users and/or UEs 148, a Dynamic Host Configuration Protocol (DHCP) server 116 for dynamically assigning network addresses (e.g., IP addresses) to UEs 148 upon authentication, a Domain Name System (DNS) server 122 for resolving domain names into network addresses, a plurality of servers 128A-128X (collectively “servers 128”) (e.g., web servers, databases servers, file servers and the like), and a network management system (NMS) 130. As shown in FIG. 1A, the various devices and systems of network 100 are coupled together via one or more network(s) 134, e.g., the Internet and/or an enterprise intranet.

In the example of FIG. 1A, NMS 130 is a cloud-based computing platform that manages wireless networks 106A-106N at one or more of sites 102A-102N. As further described herein, NMS 130 provides an integrated suite of management tools and implements various techniques of this disclosure. In general, NMS 130 may provide a cloud-based platform for wireless network data acquisition, monitoring, activity logging, reporting, predictive analytics, network anomaly identification, and alert generation. In some examples, NMS 130 outputs notifications, such as alerts, alarms, graphical indicators on dashboards, log messages, text / SMS messages, email messages, and the like, and/or recommendations regarding wireless network issues to a site or network administrator (“admin”) interacting with and/or operating admin device 111. Additionally, in some examples, NMS 130 operates in response to configuration input received from the administrator interacting with and/or operating admin device 111.

The administrator and admin device 111 may comprise IT personnel and an administrator computing device associated with one or more of sites 102 and/or switches 146 at the wired network edge. Admin device 111 may be implemented as any suitable device for presenting output and/or accepting user input. For instance, admin device 111 may include a display. Admin device 111 may be a computing system, such as a mobile or non-mobile computing device operated by a user and/or by the administrator. Admin device 111 may, for example, represent a workstation, a laptop or notebook computer, a desktop computer, a tablet computer, or any other computing device that may be operated by a user and/or present a user interface in accordance with one or more aspects of the present disclosure. Admin device 111 may be physically separate from and/or in a different location than NMS 130 such that admin device 111 may communicate with NMS 130 via network 134 or other means of communication.

In some examples, one or more of the NAS devices, e.g., APs 142, switches 146, or routers, may connect to edge devices 150A-150N via physical cables, e.g., Ethernet cables. Edge devices 150 comprise cloud-managed, wireless local area network (LAN) controllers. Each of edge devices 150 may comprise an on-premises device at a site 102 that is in communication with NMS 130 to extend certain microservices from NMS 130 to the on-premises NAS devices while using NMS 130 and its distributed software architecture for scalable and resilient operations, management, troubleshooting, and analytics.

Each one of the network devices of network system 100, e.g., servers 110, 116, 122 and/or 128, APs 142, UEs 148, switches 146, and any other servers or devices attached to or forming part of network system 100, may include a system log or an error log module wherein each one of these network devices records the status of the network device including normal operational status and error conditions. Throughout this disclosure, one or more of the network devices of network system 100, e.g., servers 110, 116, 122 and/or 128, APs 142, UEs 148, and switches 146, may be considered “third-party” network devices when owned by and/or associated with a different entity than NMS 130 such that NMS 130 does not receive, collect, or otherwise have access to the recorded status and other data of the third-party network devices. In some examples, edge devices 150 may provide a proxy through which the recorded status and other data of the third-party network devices may be reported to NMS 130.

In some examples, NMS 130 monitors network data 137, e.g., one or more service level expectation (SLE) metrics, received from wireless networks 106A-106N at each site 102A-102N, respectively, and manages network resources, such as APs 142 at each site, to deliver a high-quality wireless experience to end users, IoT devices and clients at the site. For example, NMS 130 may include a virtual network assistant (VNA) 133 that implements an event processing platform for providing real-time insights and simplified troubleshooting for IT operations, and that automatically takes corrective action or provides recommendations to proactively address wireless network issues. VNA 133 may, for example, include an event processing platform configured to process hundreds or thousands of concurrent streams of network data 137 from sensors and/or agents associated with APs 142 and/or nodes within network 134. For example, VNA 133 of NMS 130 may include an underlying analytics and network error identification engine and alerting system in accordance with various examples described herein. The underlying analytics engine of VNA 133 may apply historical data and models to the inbound event streams to compute assertions, such as identified anomalies or predicted occurrences of events constituting network error conditions. Further, VNA 133 may provide real-time alerting and reporting to notify a site or network administrator via admin device 111 of any predicted events, anomalies, trends, and may perform root cause analysis and automated or assisted error remediation. In some examples, VNA 133 of NMS 130 may apply machine learning techniques to identify the root cause of error conditions detected or predicted from the streams of network data 137. If the root cause may be automatically resolved, VNA 133 may invoke one or more corrective actions to correct the root cause of the error condition, thus automatically improving the underlying SLE metrics and also automatically improving the user experience.

Further example details of operations implemented by the VNA 133 of NMS 130 are described in U.S. Pat. No. 9,832,082, issued Nov. 28, 2017, and entitled “Monitoring Wireless Access Point Events,” U.S. Publication No. US 2021/0306201, published Sep. 30, 2021, and entitled “Network System Fault Resolution Using a Machine Learning Model,” U.S. Pat. No. 10,985,969, issued Apr. 20, 2021, and entitled “Systems and Methods for a Virtual Network Assistant,” U.S. Pat. No. 10,958,585, issued Mar. 23, 2021, and entitled “Methods and Apparatus for Facilitating Fault Detection and/or Predictive Fault Detection,” U.S. Pat. No. 10,958,537, issued Mar. 23, 2021, and entitled “Method for Spatio-Temporal Modeling,” and U.S. Patent No. 10,862,742, issued Dec. 8, 2020, and entitled “Method for Conveying AP Error Codes Over BLE Advertisements,” all of which are incorporated herein by reference in their entirety.

In operation, NMS 130 observes, collects and/or receives network data 137, which may take the form of data extracted from messages, counters, and statistics, for example. In accordance with one specific implementation, a computing device is part of NMS 130. In accordance with other implementations, NMS 130 may comprise one or more computing devices, dedicated servers, virtual machines, containers, services, or other forms of environments for performing the techniques described herein. Similarly, computational resources and components implementing VNA 133 may be part of the NMS 130, may execute on other servers or execution environments, or may be distributed to nodes within network 134 (e.g., routers, switches, controllers, gateways, and the like).

In accordance with one or more techniques of this disclosure, NMS 130 may be configured to determine a suggested filter attribute for narrowing down results for an entity search and/or troubleshooting a network. Examples of a suggested filter attribute may include, for example, a site, a service (e.g., Wi-Fi), an operating system, a manufacturer or vender, a user (e.g., a company, business unit of a company, or a human user), an operational status (e.g., operational or not operational), or a radio band (e.g., a channel in Wi-Fi or Bluetooth™).

In some examples, the site or network administrator, e.g., using admin device 111, may initiate an entity search and/or troubleshooting of networking services via a conversational assistant engine 136 of VNA 133. Conversational assistant engine 136 may be configured to process user inputs, such as text strings, and generate responses. In some examples, conversational assistant engine 136 may include one or more natural language processors configured to process the user inputs. Conversational assistant engine 136 may be configured to conduct a chat conversation that simulates a way a human would behave as a conversation partner, which may help to simplify and/or improve a satisfaction of an administrator monitoring and controlling a network.

Conversational assistant engine 136 may generate a conversational assistant configured to receive user input. In a specific use case, the admin, via admin device 111, may enter a query requesting to troubleshooting entities into conversational assistant engine 136. Conversational assistant engine 136 may provide a platform in which to present the suggested filter attribute to the admin and with which the admin may select the suggested filter attribute to reduce a number of network devices in response to the initial query for purposes of entity identification and/or entity troubleshooting.

For example, conversational assistant engine 136 may receive a text string indicating the entity from the admin via admin device 111. For instance, conversational assistant engine 136 may receive a string indicating an application, a duration, and/or a device identifier (e.g., “troubleshoot teams call from client device A,” where “teams call” indicates the application and “client device A” comprises a client device identifier; or “how is DC84AP544 during last 7 days,” where “DC84AP544” comprises an AP device identifier and “7 days,” indicates a duration). In some instances, conversational assistant engine 136 may receive a string indicating the application, a duration, and/or a user identifier (e.g., “troubleshoot user B teams call,” where “user B” is a user of a client device and “teams call” indicates the application). Conversational assistant engine 136 may determine the particular entity (e.g., a network device of the plurality of network devices) based on the user input.

Suggested filter attribute engine 135 may determine a list of network devices from the plurality of network devices based on an entity type. For example, in response to the conversational assistant engine 136 determining that the entity refers to a software application (e.g., Microsoft Teams®), suggested filter attribute engine 135 may determine a list of network devices that used the software application within a time period (e.g., as specified in the query or a preconfigured time period).

Suggested filter attribute engine 135 may determine a suggested filter attribute based on the list of network devices and one or more of a user profile, a current state of the plurality of network devices, or a current state of the networking services. For example, suggested filter attribute engine 135 may determine the suggested filter attribute for one or more sites of the plurality of sites based on a usage of the application. For instance, suggested filter attribute engine 135 may determine, based on a user profile stored in network data 137, that a user associated with the query is assigned a set of sites. In this instance, suggested filter attribute engine 135 may determine one or more sites from the set of sites based on a respective usage of the application at each site of the set of sites. For instance, suggested filter attribute engine 135 may omit sites from the set of sites that have no usage of the application or have a usage of the application that is less than a threshold value.

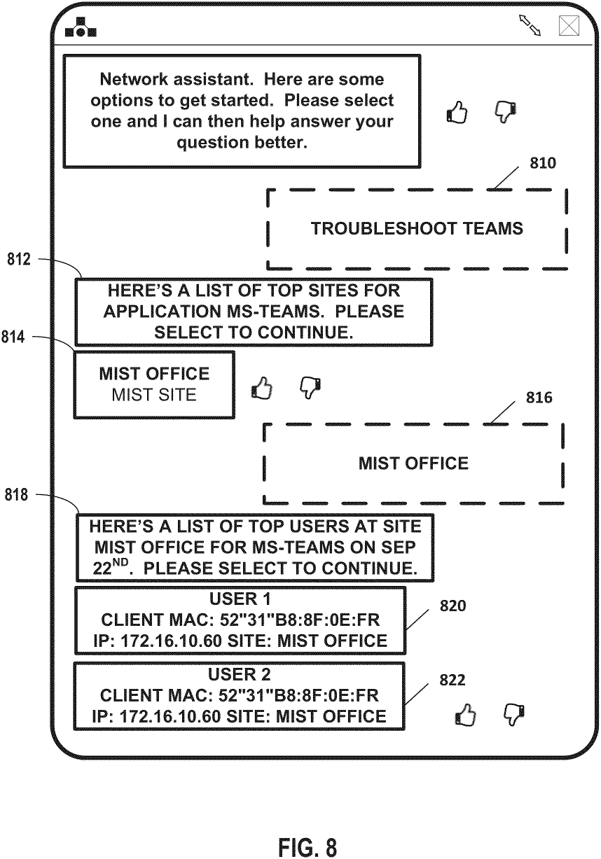

Conversational assistant engine 136 may output, in a user interface, an indication of the suggested filter attribute. For example, conversational assistant engine 136 may generate data representative of a user interface for presentation on an administrator device. The user interface may include a visualization of the suggested filter attribute (see FIG. 8). The visualization may include color-coding, icons, or other indicia of the suggested filter attribute.

Suggested filter attribute engine 135 may receive user input representative of a selection of the indication of the suggested filter attribute. For instance, a user may interact with (e.g., use a mouse to select a graphical element of the indication of the suggested filter attribute or touch the graphical element in a touch screen) to select the indication of the suggested filter attribute. Suggested filter attribute engine 135 may, in response to receiving the user input representative of the selection of the indication of the suggested filter attribute, determine a filtered list of network devices from the list of network devices using the suggested filter attribute and output, in the user interface, an indication of the filtered list of network devices. For example, suggested filter attribute engine 135 may further filter the network devices from the list of network devices to the filtered list of network devices using the suggested filter attribute (e.g., a specific site). In some examples, suggested filter attribute engine 135 may redirect the user to a customer insight or recommended action user interface specific to one or more network device of the filtered list of network devices. Additional information with respect to the conversational assistant is described in U.S. Pat. Application No. 17/647,954, filed Jan. 13, 2022, entitled “CONVERSATIONAL ASSISTANT FOR OBTAINING NETWORK INFORMATION,” (Docket No. JNP3538-US / 2014-515US01), the entire content of which is incorporated herein by reference in its entirety.

The techniques of this disclosure provide one or more technical advantages and practical applications. For example, the techniques enable determination of a suggested filter attribute to enable improved troubleshooting by suggesting filter attribute(s) that may be intuitive to the administrator for helping to filter or further filter the list of devices, which may help to reduce an amount of time a network issue occurs and/or reduce an amount of time an administrator spends searching for a particular device and/or troubleshooting a particular device or set of devices within a network. For example, rather than relying solely on the administrator to provide filters to identify network devices, VNA 133 may prompt a user to select a filter attribute (e.g., a particular site from a filter attribute suggesting to filter by sites). In response to user input selecting the filter attribute, VNA 133 may further generate a filtered list of network devices and output an indication of the filtered list of network devices to a user interface for review by the administrator.

FIG. 1B is a block diagram illustrating further example details of the network system of FIG. 1A. In this example, FIG. 1B illustrates NMS 130 configured to operate according to an artificial intelligence and/or machine-learning-based computing platform providing comprehensive automation, insight, and assurance (Wi-Fi Assurance, Wired Assurance and WAN assurance) spanning from “client,” e.g., user devices 148 connected to wireless network 106 and wired LAN 175 at the network edge (far left of FIG. 1B), to “cloud,” e.g., cloud-based application services 181 that may be hosted by computing resources within data centers 179 (far right of FIG. 1B).

As described herein, NMS 130 provides an integrated suite of management tools and implements various techniques of this disclosure. In general, NMS 130 may provide a cloud-based platform for wireless network data acquisition, monitoring, activity logging, reporting, predictive analytics, network anomaly identification, and alert generation. For example, network management system 130 may be configured to proactively monitor and adaptively configure network 100 so as to provide self-driving capabilities. Moreover, VNA 133 includes a natural language processing engine to provide AI-driven support and troubleshooting, anomaly detection, AI-driven location services, and AI-driven radio frequency (RF) optimization with reinforcement learning.

As illustrated in the example of FIG. 1B, AI-driven NMS 130 also provides configuration management, monitoring and automated oversight of software defined wide-area network (SD-WAN) 177, which operates as an intermediate network communicatively coupling wireless networks 106 and wired LANs 175 to data centers 179 and application services (e.g., multicloud apps) 181. In general, SD-WAN 177 provides seamless, secure, traffic-engineered connectivity between “spoke” routers 187A of edge wired networks 175 hosting wireless networks 106, such as branch or campus networks, to “hub” routers 187B further up the cloud stack toward cloud-based application services 181. SD-WAN 177 often operates and manages an overlay network on an underlying physical Wide-Area Network (WAN), which provides connectivity to geographically separate customer networks. In other words, SD-WAN 177 extends Software-Defined Networking (SDN) capabilities to a WAN and allows network(s) to decouple underlying physical network infrastructure from virtualized network infrastructure and applications such that the networks may be configured and managed in a flexible and scalable manner.

In some examples, underlying routers of SD-WAN 177 may implement a stateful, session-based routing scheme in which the routers 187A, 187B dynamically modify contents of original packet headers sourced by client devices 148 to steer traffic along selected paths, e.g., path 189, toward application services 181 without requiring use of tunnels and/or additional labels. In this way, routers 187A, 187B may be more efficient and scalable for large networks since the use of tunnel-less, session-based routing may enable routers 187A, 187B to achieve considerable network resources by obviating the need to perform encapsulation and decapsulation at tunnel endpoints. Moreover, in some examples, each router 187A, 187B may independently perform path selection and traffic engineering to control packet flows associated with each session without requiring use of a centralized SDN controller for path selection and label distribution. In some examples, routers 187A, 187B implement session-based routing as Secure Vector Routing (SVR), provided by Juniper Networks, Inc.

Additional information with respect to session-based routing and SVR is described in U.S. Pat. No. 9,729,439, entitled “COMPUTER NETWORK PACKET FLOW CONTROLLER,” and issued on Aug. 8, 2017; U.S. Pat. No. 9,729,682, entitled “NETWORK DEVICE AND METHOD FOR PROCESSING A SESSION USING A PACKET SIGNATURE,” and issued on Aug. 8, 2017; U.S. Pat. No. 9,762,485, entitled “NETWORK PACKET FLOW CONTROLLER WITH EXTENDED SESSION MANAGEMENT,” and issued on Sep. 12, 2017; U.S. Pat. No. 9,871,748, entitled “ROUTER WITH OPTIMIZED STATISTICAL FUNCTIONALITY,” and issued on Jan. 16, 2018; U.S. Pat. No. 9,985,883, entitled “NAME-BASED ROUTING SYSTEM AND METHOD,” and issued on May 29, 2018; U.S. Pat. No. 10,200,264, entitled “LINK STATUS MONITORING BASED ON PACKET LOSS DETECTION,” and issued on Feb. 5, 2019; U.S. Pat. No. 10,277,506, entitled “STATEFUL LOAD BALANCING IN A STATELESS NETWORK,” and issued on Apr. 30, 2019; U.S. Pat. No. 10,432,522, entitled “NETWORK PACKET FLOW CONTROLLER WITH EXTENDED SESSION MANAGEMENT,” and issued on Oct. 1, 2019; and U.S. Pat. No. 11,075,824, entitled “IN-LINE PERFORMANCE MONITORING,” and issued on Jul. 27, 2021, the entire content of each of which is incorporated herein by reference in its entirety.

In some examples, AI-driven NMS 130 may enable intent-based configuration and management of network system 100, including enabling construction, presentation, and execution of intent-driven workflows for configuring and managing devices associated with wireless networks 106, wired LAN networks 175, and /or SD-WAN 177. For example, declarative requirements express a desired configuration of network components without specifying an exact native device configuration and control flow. By utilizing declarative requirements, what should be accomplished may be specified rather than how it should be accomplished. Declarative requirements may be contrasted with imperative instructions that describe the exact device configuration syntax and control flow to achieve the configuration. By utilizing declarative requirements rather than imperative instructions, a user and/or user system is relieved of the burden of determining the exact device configurations required to achieve a desired result of the user/system. For example, it is often difficult and burdensome to specify and manage exact imperative instructions to configure each device of a network when various different types of devices from different vendors are utilized. The types and kinds of devices of the network may dynamically change as new devices are added and device failures occur. Managing various different types of devices from different vendors with different configuration protocols, syntax, and software versions to configure a cohesive network of devices is often difficult to achieve. Thus, by only requiring a user/system to specify declarative requirements that specify a desired result applicable across various different types of devices, management and configuration of the network devices becomes more efficient. Further example details and techniques of an intent-based network management system are described in U.S. Pat. 10,756,983, entitled “Intent-based Analytics,” and U.S. Pat. 10,992,543, entitled “Automatically generating an intent-based network model of an existing computer network,” each of which is hereby incorporated by reference.

In accordance with the techniques described in this disclosure, suggested filter attribute engine 135 of VNA 133 may determine a suggested filter attribute based on the list of network devices and one or more of a user profile stored by network data 137, a current state of the plurality of network devices stored by network data 137, or a current state of the networking services stored by network data 137. For example, suggested filter attribute engine 135 may determine the suggested filter attribute for one or more sites of the plurality of sites based on a usage of the application. For instance, suggested filter attribute engine 135 may determine, based on a user profile stored in network data 137, that a user associated with the query is assigned a set of sites. In this instance, suggested filter attribute engine 135 may determine one or more sites from the set of sites based on a respective usage of the application at each site of the set of sites. For instance, suggested filter attribute engine 135 may omit sites from the set of sites that have no usage of the application or have a usage of the application that is less than a threshold. The disclosed techniques enable simplified search and/or troubleshooting of the network, particularly in networks with numerous network devices and/or supporting numerous networking services. In this way, VNA 133 provides improved search and/or troubleshooting by suggesting filter attribute(s) that may be intuitive to the administrator for helping to filter or further filter the list of devices, which may help to reduce an amount of time a network issue occurs and/or reduce an amount of time an administrator spends searching for a particular device and/or troubleshooting a particular device or set of devices within a network.

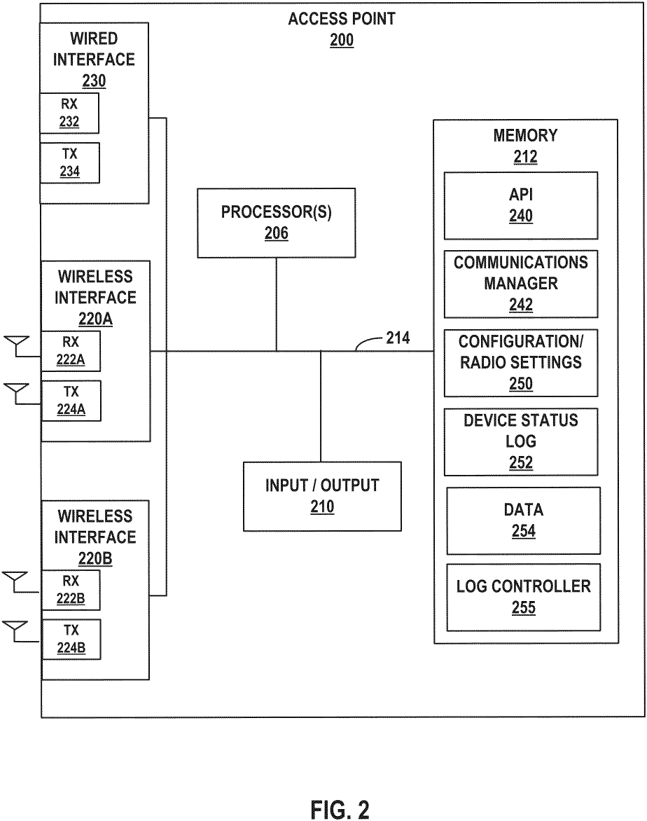

FIG. 2 is a block diagram of an example access point (AP) device 200 configured in accordance with one or more techniques of this disclosure. Example access point 200 shown in FIG. 2 may be used to implement any of APs 142 as shown and described herein with respect to FIG. 1A. Access point 200 may comprise, for example, a Wi-Fi, Bluetooth and/or Bluetooth Low Energy (BLE) base station or any other type of wireless access point.

In the example of FIG. 2, access point 200 includes a wired interface 230, wireless interfaces 220A-220B one or more processor(s) 206, memory 212, and input/output 210, coupled together via a bus 214 over which the various elements may exchange data and information. Wired interface 230 represents a physical network interface and includes a receiver 232 and a transmitter 234 for sending and receiving network communications, e.g., packets. Wired interface 230 couples, either directly or indirectly, access point 200 to a wired network device, such as one of switches 146 of FIG. 1A, within the wired network via a cable, such as an Ethernet cable.

First and second wireless interfaces 220A and 220B represent wireless network interfaces and include receivers 222A and 222B, respectively, each including a receive antenna via which access point 200 may receive wireless signals from wireless communications devices, such as UEs 148 of FIG. 1A. First and second wireless interfaces 220A and 220B further include transmitters 224A and 224B, respectively, each including transmit antennas via which access point 200 may transmit wireless signals to wireless communications devices, such as UEs 148 of FIG. 1A. In some examples, first wireless interface 220A may include a Wi-Fi 802.11 interface (e.g., 2.4 GHz and/or 5 GHz) and second wireless interface 220B may include a Bluetooth interface and/or a Bluetooth Low Energy (BLE) interface.

Processor(s) 206 are programmable hardware-based processors configured to execute software instructions, such as those used to define a software or computer program, stored to a computer-readable storage medium (such as memory 212), such as non-transitory computer-readable mediums including a storage device (e.g., a disk drive, or an optical drive) or a memory (such as Flash memory or RAM) or any other type of volatile or non-volatile memory, that stores instructions to cause the one or more processors 206 to perform the techniques described herein.

Memory 212 includes one or more devices configured to store programming modules and/or data associated with operation of access point 200. For example, memory 212 may include a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause the one or more processor(s) 206 to perform the techniques described herein.

In this example, memory 212 stores executable software including an application programming interface (API) 240, a communications manager 242, configuration/radio settings 250, a device status log 252 and data 254. Device status log 252 includes a list of events specific to access point 200. The events may include a log of both normal events and error events such as, for example, memory status, reboot or restart events, crash events, cloud disconnect with self-recovery events, low link speed or link speed flapping events, Ethernet port status, Ethernet interface packet errors, upgrade failure events, firmware upgrade events, configuration changes, etc., as well as a time and date stamp for each event. Log controller 255 determines a logging level for the device based on instructions from NMS 130. Data 254 may store any data used and/or generated by access point 200, including data collected from UEs 148, such as data used to calculate one or more SLE metrics, that is transmitted by access point 200 for cloud-based management of wireless networks 106A by NMS 130.

Input/output (I/O) 210 represents physical hardware components that enable interaction with a user, such as buttons, a display, and the like. Although not shown, memory 212 typically stores executable software for controlling a user interface with respect to input received via I/O 210. Communications manager 242 includes program code that, when executed by processor(s) 206, allow access point 200 to communicate with UEs 148 and/or network(s) 134 via any of interface(s) 230 and/or 220A-220C. Configuration settings 250 include any device settings for access point 200 such as radio settings for each of wireless interface(s) 220A-220C. These settings may be configured manually or may be remotely monitored and managed by NMS 130 to optimize wireless network performance on a periodic (e.g., hourly or daily) basis.

As described herein, AP device 200 may measure and report network data from status log 252 to NMS 130. The network data may comprise event data, telemetry data, and/or other SLE-related data. The network data may include various parameters indicative of the performance and/or status of the wireless network. The parameters may be measured and/or determined by one or more of the UE devices and/or by one or more of the APs in a wireless network. NMS 130 may determine one or more SLE metrics based on the SLE-related data received from the APs in the wireless network and store the SLE metrics as network data 137 (FIG. 1A). NMS 130 may further update temporal graph database 138 (FIG. 1A) of the network to include the telemetry data, or at least entity and connectivity information extracted from the telemetry data, received from the APs in the wireless network over time.

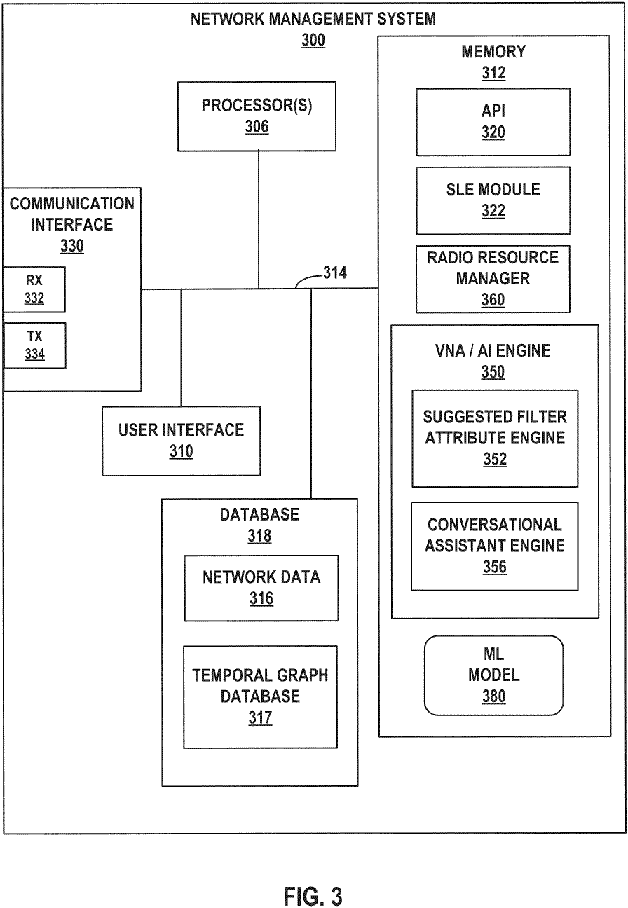

FIG. 3 is a block diagram of an example network management system (NMS) 300 configured to suggest a filter attribute, in accordance with one or more techniques of the disclosure. NMS 300 may be used to implement, for example, NMS 130 in FIGS. 1A-1B. In such examples, NMS 300 is responsible for monitoring and management of one or more wireless networks 106A-106N at sites 102A-102N, respectively.

NMS 300 includes a communications interface 330, one or more processor(s) 306, a user interface 310, a memory 312, and a database 318. The various elements are coupled together via a bus 314 over which the various elements may exchange data and information. In some examples, NMS 300 receives data from one or more of client devices 148, APs 142, switches 146 and other network nodes within network 134, e.g., routers 187 of FIG. 1B, which may be used to calculate one or more SLE metrics and/or update temporal graph database 317. NMS 300 analyzes this data for cloud-based management of wireless networks 106A-106N. The received data is stored as network data 316 in database 318, and the telemetry data included in the received data, or at least entity and connectivity information extracted from the telemetry data, is stored within temporal graph database 317 in database 318. In some examples, NMS 300 may be part of another server shown in FIG. 1A or a part of any other server.

Processor(s) 306 execute software instructions, such as those used to define a software or computer program, stored to a computer-readable storage medium (such as memory 312), such as non-transitory computer-readable mediums including a storage device (e.g., a disk drive, or an optical drive) or a memory (such as Flash memory or RAM) or any other type of volatile or non-volatile memory, that stores instructions to cause the one or more processors 306 to perform the techniques described herein.

Communications interface 330 may include, for example, an Ethernet interface. Communications interface 330 couples NMS 300 to a network and/or the Internet, such as any of network(s) 134 as shown in FIG. 1A, and/or any local area networks. Communications interface 330 includes a receiver 332 and a transmitter 334 by which NMS 300 receives/transmits data and information to/from any of client devices 148, APs 142, switches 146, servers 110, 116, 122, 128 and/or any other network nodes, devices, or systems forming part of network system 100 such as shown in FIG. 1A. In some scenarios described herein in which network system 100 includes “third-party” network devices that are owned and/or associated with different entities than NMS 300, NMS 300 does not receive, collect, or otherwise have access to network data from the third-party network devices.

The data and information received by NMS 300 may include, for example, telemetry data, SLE-related data, or event data received from one or more of client device APs 148, APs 142, switches 146, or other network nodes, e.g., routers 187 of FIG. 1B, used by NMS 300 to remotely monitor the performance of wireless networks 106A-106N and application sessions from client device to cloud-based application server. NMS 300 may further transmit data via communications interface 330 to any of network devices such as client devices 148, APs 142, switches 146, other network nodes within network 134, admin device 111 to remotely manage wireless networks 106A-106N and portions of the wired network.

Memory 312 includes one or more devices configured to store programming modules and/or data associated with operation of NMS 300. For example, memory 312 may include a computer-readable storage medium, such as a non-transitory computer-readable medium including a storage device (e.g., a disk drive, or an optical drive) or a memory (such as Flash memory or RAM) or any other type of volatile or non-volatile memory, that stores instructions to cause the one or more processor(s) 306 to perform the techniques described herein.

In this example, memory 312 includes an API 320, an SLE module 322, a virtual network assistant (VNA)/AI engine 350, and a radio resource manager (RRM) 360. In accordance with the disclosed techniques, VNA/AI engine 350 includes suggested filter attribute engine 352 that suggests a filter attribute to reduce a number of devices to troubleshoot. Filter attribute engine 352, in some examples, applies a ML model 380 to network data 316 and/or temporal graph database 317 to perform troubleshooting by identifying root causes of connectivity issues at one or more of the subset of network devices. NMS 300 may also include any other programmed modules, software engines and/or interfaces configured for remote monitoring and management of wireless networks 106A-106N and portions of the wired network, including remote monitoring and management of any of APs 142/200, switches 146, or other network devices, e.g., routers 187 of FIG. 1B.

SLE module 322 enables set up and tracking of thresholds for SLE metrics for each network 106A-106N. SLE module 322 further analyzes SLE-related data collected by APs, such as any of APs 142 from UEs in each wireless network 106A-106N. For example, APs 142A-1 through 142A-N collect SLE-related data from UEs 148A-1through 148A-N currently connected to wireless network 106A. This data is transmitted to NMS 300, which executes by SLE module 322 to determine one or more SLE metrics for each UE 148A-1 through 148A-N currently connected to wireless network 106A. This data, in addition to any network data collected by one or more APs 142A-1 through 142A-N in wireless network 106A, is transmitted to NMS 300 and stored as, for example, network data 316 in database 318.

RRM engine 360 monitors one or more metrics for each site 102A-102N in order to learn and optimize the RF environment at each site. For example, RRM engine 360 may monitor the coverage and capacity SLE metrics for a wireless network 106 at a site 102 in order to identify potential issues with SLE coverage and/or capacity in the wireless network 106 and to make adjustments to the radio settings of the access points at each site to address the identified issues. For example, RRM engine 360 may determine channel and transmit power distribution across all APs 142 in each network 106A-106N. For example, RRM engine 360 may monitor events, power, channel, bandwidth, and number of clients connected to each AP. RRM engine 360 may further automatically change or update configurations of one or more APs 142 at a site 102 with an aim to improve the coverage and capacity SLE metrics and thus to provide an improved wireless experience for the user.

VNA/AI engine 350 analyzes data received from network devices as well as its own data to identify when undesired to abnormal states are encountered at one of the network devices. For example, VNA/AI engine 350 may identify the root cause of any undesired or abnormal states, e.g., any poor SLE metric(s) indicative of connected issues at one or more network devices. In addition, VNA/AI engine 350 may automatically invoke one or more corrective actions intended to address the identified root cause(s) of one or more poor SLE metrics. Examples of corrective actions that may be automatically invoked by VNA/AI engine 350 may include, but are not limited to, invoking RRM 360 to reboot one or more APs, adjusting/modifying the transmit power of a specific radio in a specific AP, adding SSID configuration to a specific AP, changing channels on an AP or a set of APs, etc. The corrective actions may further include restarting a switch and/or a router, invoking downloading of new software to an AP, switch, or router, etc. These corrective actions are given for example purposes only, and the disclosure is not limited in this respect. If automatic corrective actions are not available or do not adequately resolve the root cause, VNA/AI engine 350 may proactively provide a notification including recommended corrective actions to be taken by IT personnel, e.g., a site or network administrator using admin device 111, to address the network error.

In accordance with one or more techniques of this disclosure, NMS 300 may be configured to determine a suggested filter attribute for narrowing results of an entity search and/or troubleshooting a network. Examples of a suggested filter attribute may include, for example, one or more sites, one or more services (e.g., Wi-Fi), one or more operating systems, one or more manufacturer or venders, one or more users (e.g., companies, business units of a company, or human users), operational statuses (e.g., operational or not operational), or one or more radio bands (e.g., a channel in Wi-Fi or Bluetooth™).

In some examples, the site or network administrator, e.g., using admin device 111, may initiate troubleshooting of networking services via a conversational assistant engine 356 of VNA 350. Conversational assistant engine 356 may be configured to process user inputs, such as text strings, and generate responses. In some examples, conversational assistant engine 356 may include one or more natural language processors configured to process the user inputs. Conversational assistant engine 356 may be configured to conduct a chat conversation that simulates a way a human would behave as a conversation partner, which may help to simplify and/or improve a satisfaction of an administrator monitoring and controlling a network.

In accordance with one or more techniques of the disclosure, conversational assistant engine 356 may generate a conversational assistant configured to receive user input. In a specific use case, the admin, via admin device 111, may enter a query troubleshooting entities into conversational assistant engine 356. Conversational assistant engine 356 may provide a platform in which to present the suggested filter attribute to the admin and with which the admin may select to reduce a number of network devices to troubleshoot.

For example, conversational assistant engine 356 may receive a string indicating the entity. For instance, conversational assistant engine 356 may receive a string indicating an application, a duration, and/or a device identifier (e.g., “troubleshoot teams call from client device A,” where “teams call” indicates the application and “client device A” comprises a client device identifier; or “how is DC84AP544 during last 7 days,” where “DC84AP544” comprises an AP device identifier and “7 days,” indicates a duration). In some instances, conversational assistant engine 356 may receive a string indicating the application, a duration, and/or a user identifier (e.g., “troubleshoot user B teams call,” where “user B” is a user of a client device and “teams call” indicates the application). Conversational assistant engine 356 may determine the particular entity (e.g., a network device of the plurality of network devices) based on the user input.

Suggested filter attribute engine 352 may determine a list of network devices from the plurality of network devices based on an entity type. For example, in response to the conversational assistant engine 356 determining that the entity refers to a software application (e.g., Microsoft Teams®), suggested filter attribute engine 352 may determine a list of network devices that used the software application within a time period (e.g., a specified in the query or a preconfigured time period).

Suggested filter attribute engine 352 may determine a suggested filter attribute based on the list of network devices and one or more of a user profile, a current state of the plurality of network devices, or a current state of the networking services. For example, suggested filter attribute engine 352 may determine the suggested filter attribute for one or more sites of the plurality of sites based on a usage of the application. For instance, suggested filter attribute engine 352 may determine, based on a user profile stored in network data 137, that a user associated with the query is assigned a set of sites. In this instance, suggested filter attribute engine 352 may determine one or more sites from the set of sites based on a respective usage of the application at each site of the set of sites. For instance, suggested filter attribute engine 352 may omit sites from the set of sites that have no usage of the application or have a usage of the application that is less than a threshold.

Conversational assistant engine 356 may output, in a user interface, an indication of the suggested filter attribute. For example, conversational assistant engine 356 may generate data representative of a user interface for presentation on an administrator device. The user interface may include a visualization of the suggested filter attribute (see FIG. 8). The visualization may include color-coding, icons, or other indicia of the suggested filter attribute.

Suggested filter attribute engine 352 may receive user input representative of a selection of the indication of the suggested filter attribute. For instance, a user may interact with (e.g., use a mouse to select a graphical element of the indication of the suggested filter attribute or touch the graphical element in a touch screen) to select the indication of the suggested filter attribute. Suggested filter attribute engine 352 may, in response to receiving the user input representative of the selection of the indication of the suggested filter attribute, determine a filtered list of network devices from the list of network devices using the suggested filter attribute and output, in the user interface, an indication of the filtered list of network devices. For example, suggested filter attribute engine 135 may further filter the network devices from the list of network devices to the filtered list of network devices using the suggested filter attribute (e.g., a specific site). In some examples, suggested filter attribute engine 352 may redirect the user to a customer insight or recommended action user interface specific to one or more network device of the filtered list of network devices.

The techniques of this disclosure provide one or more technical advantages and practical applications. For example, the techniques enable determination of a suggested filter attribute to enable improved searching and/or troubleshooting by suggesting filter attribute(s) that may be intuitive to the administrator for helping to filter or further filter the list of devices, which may help to reduce an amount of time a network issue occurs and/or reduce an amount of time an administrator spends searching for a particular device and/or troubleshooting a particular device or set of devices within a network. For example, rather than relying solely on the administrator to provide filters to identify network devices, VNA 350 may prompt a user to select a filter attribute (e.g., a particular site from a filter attribute suggesting to filter by sites). In response to user input selecting the filter attribute, VNA 350 may further generate a filtered list of network devices and output an indication of the a filtered list of network devices to a user interface for review by the administrator.

Although the techniques of the present disclosure are described in this example as performed by NMS 130, techniques described herein may be performed by any other computing device(s), system(s), and/or server(s), and that the disclosure is not limited in this respect. For example, one or more computing device(s) configured to execute the functionality of the techniques of this disclosure may reside in a dedicated server or be included in any other server in addition to or other than NMS 130, or may be distributed throughout network 100, and may or may not form a part of NMS 130.

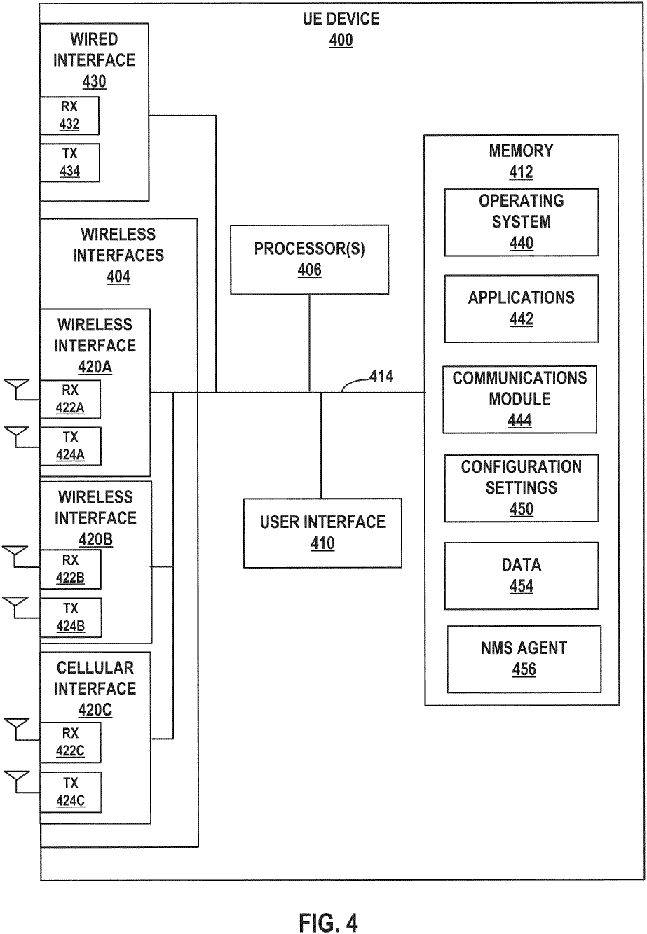

FIG. 4 shows an example user equipment (UE) device 400. Example UE device 400 shown in FIG. 4 may be used to implement any of UEs 148 as shown and described herein with respect to FIG. 1A. UE device 400 may include any type of wireless client device, and the disclosure is not limited in this respect. For example, UE device 400 may include a mobile device such as a smart phone, tablet or laptop computer, a personal digital assistant (PDA), a wireless terminal, a smart watch, a smart ring, or any other type of mobile or wearable device. In accordance with techniques described in this disclosure, UE 400 may also include a wired client-side device, e.g., an IoT device such as a printer, a security sensor or device, an environmental sensor, or any other device connected to the wired network and configured to communicate over one or more wireless networks.

UE device 400 includes a wired interface 430, wireless interfaces 420A-420C, one or more processor(s) 406, memory 412, and a user interface 410. The various elements are coupled together via a bus 414 over which the various elements may exchange data and information. Wired interface 430 represents a physical network interface and includes a receiver 432 and a transmitter 434. Wired interface 430 may be used, if desired, to couple, either directly or indirectly, UE 400 to a wired network device, such as one of switches 146 of FIG. 1A, within the wired network via a cable, such as one of Ethernet cables 144 of FIG. 1A.

First, second and third wireless interfaces 420A, 420B, and 420C include receivers 422A, 422B, and 422C, respectively, each including a receive antenna via which UE 400 may receive wireless signals from wireless communications devices, such as APs 142 of FIG. 1A, AP 200 of FIG. 2, other UEs 148, or other devices configured for wireless communication. First, second, and third wireless interfaces 420A, 420B, and 420C further include transmitters 424A, 424B, and 424C, respectively, each including transmit antennas via which UE 400 may transmit wireless signals to wireless communications devices, such as APs 142 of FIG. 1A, AP 200 of FIG. 2, other UEs 148 and/or other devices configured for wireless communication. In some examples, first wireless interface 420A may include a Wi-Fi 802.11 interface (e.g., 2.4 GHz and/or 5 GHz) and second wireless interface 420B may include a Bluetooth interface and/or a Bluetooth Low Energy interface. Third wireless interface 420C may include, for example, a cellular interface through which UE device 400 may connect to a cellular network.

Processor(s) 406 execute software instructions, such as those used to define a software or computer program, stored to a computer-readable storage medium (such as memory 412), such as non-transitory computer-readable mediums including a storage device (e.g., a disk drive, or an optical drive) or a memory (such as Flash memory or RAM) or any other type of volatile or non-volatile memory, that stores instructions to cause the one or more processors 406 to perform the techniques described herein.

Memory 412 includes one or more devices configured to store programming modules and/or data associated with operation of UE 400. For example, memory 412 may include a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause the one or more processor(s) 406 to perform the techniques described herein.

In this example, memory 412 includes an operating system 440, applications 442, a communications module 444, configuration settings 450, and data 454. Communications module 444 includes program code that, when executed by processor(s) 406, enables UE 400 to communicate using any of wired interface(s) 430, wireless interfaces 420A-420B and/or cellular interface 450C. Configuration settings 450 include any device settings for UE 400 settings for each of wireless interface(s) 420A-420B and/or cellular interface 420C.

Data 454 may include, for example, a status/error log including a list of events specific to UE 400. The events may include a log of both normal events and error events according to a logging level based on instructions from NMS 130. Data 454 may include any data used and/or generated by UE 400, such as data used to calculate one or more SLE metrics or identify relevant behavior data, that is collected by UE 400 and either transmitted directly to NMS 130 or transmitted to any of APs 142 in a wireless network 106 for further transmission to NMS 130.

As described herein, UE 400 may measure and report network data from data 454 to NMS 130. The network data may comprise event data, telemetry data, and/or other SLE-related data. The network data may include various parameters indicative of the performance and/or status of the wireless network. NMS 130 may determine one or more SLE metrics and store the SLE metrics as network data 137 (FIG. 1A) based on the SLE-related data received from the UEs or client devices in the wireless network. NMS 130 may further update temporal graph database 138 (FIG. 1A) of the network to include the telemetry data, or at least entity and connectivity information extracted from the telemetry data, received from the UEs or client devices in the wireless network over time.

NMS agent 456 is a software agent of NMS 130 that is installed on UE 400. In some examples, NMS agent 456 can be implemented as a software application running on UE 400. NMS agent 456 collects information including detailed client-device properties from UE 400, including insight into UE 400 roaming behaviors. The information provides insight into client roaming algorithms, because roaming is a client device decision. In some examples, NMS agent 456 may display the client-device properties on UE 400. NMS agent 456 sends the client device properties to NMS 130, via an AP device to which UE 400 is connected. NMS agent 456 can be integrated into a custom application or as part of location application. NMS agent 456 may be configured to recognize device connection types (e.g., cellular or Wi-Fi), along with the corresponding signal strength. For example, NMS agent 456 recognizes access point connections and their corresponding signal strengths. NMS agent 456 can store information specifying the APs recognized by UE 400 as well as their corresponding signal strengths. NMS agent 456 or other element of UE 400 also collects information about which APs the UE 400 connected with, which also indicates which APs the UE 400 did not connect with. NMS agent 456 of UE 400 sends this information to NMS 130 via its connected AP. In this manner, UE 400 sends information about not only the AP that UE 400 connected with, but also information about other APs that UE 400 recognized and did not connect with, and their signal strengths. The AP in turn forwards this information to the NMS, including the information about other APs the UE 400 recognized besides itself. This additional level of granularity enables NMS 130, and ultimately network administrators, to better determine the Wi-Fi experience directly from the client device’s perspective.

In some examples, NMS agent 456 further enriches the client device data leveraged in service levels. For example, NMS agent 456 may go beyond basic fingerprinting to provide supplemental details into properties such as device type, manufacturer, and different versions of operating systems. In the detailed client properties, the NMS 130 can display the Radio Hardware and Firmware information of UE 400 received from NMS client agent 456. The more details the NMS agent 456 can draw out, the better the VNA/AI engine gets at advanced device classification. The VNA/AI engine of the NMS 130 continually learns and becomes more accurate in its ability to distinguish between device-specific issues or broad device issues, such as specifically identifying that a particular operation system (OS) version is affecting certain clients.

In some examples, NMS agent 456 may cause user interface 410 to display a prompt that prompts an end user of UE 400 to enable location permissions before NMS agent 456 is able to report the device’s location, client information, and network connection data to the NMS. NMS agent 456 will then start reporting connection data to the NMS along with location data. In this manner, the end user of the client device can control whether the NMS agent 456 is enabled to report client device information to the NMS.

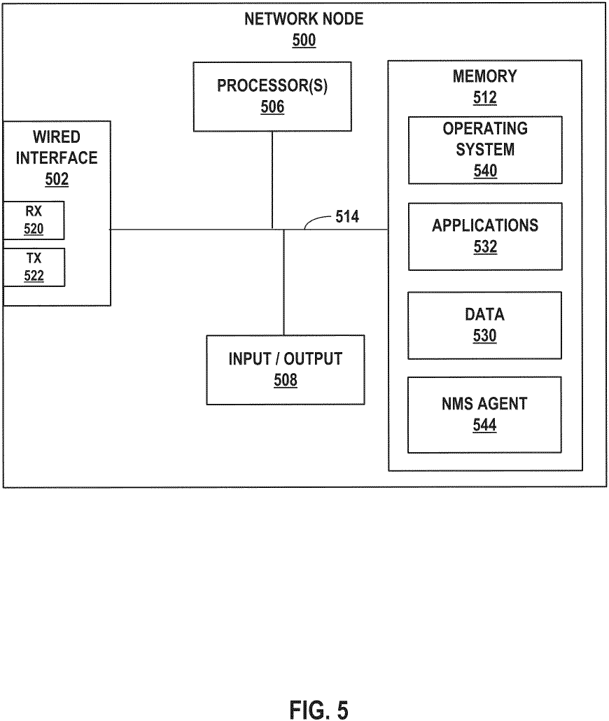

FIG. 5 is a block diagram illustrating an example network node 500 configured according to the techniques described herein. In one or more examples, the network node 500 implements a device or a server attached to the network 134 of FIG. 1A, e.g., switches 146, AAA server 110, DHCP server 116, DNS server 122, web servers 128, etc., or another network device supporting one or more of wireless network 106, wired LAN 175, or SD-WAN 177, or data center 179 of FIG. 1B, e.g., routers 187.

In this example, network node 500 includes a wired interface 502, e.g., an Ethernet interface, one or more processor(s) 506, input/output 508, e.g., display, buttons, keyboard, keypad, touch screen, mouse, etc., and a memory 512 coupled together via a bus 514 over which the various elements may interchange data and information. Wired interface 502 couples the network node 500 to a network, such as an enterprise network. Though only one interface is shown by way of example, network nodes may, and usually do, have multiple communication interfaces and/or multiple communication interface ports. Wired interface 502 includes a receiver 520 and a transmitter 522.

Memory 512 stores executable software applications 532, operating system 540 and data 530. Data 530 may include a system log and/or an error log that stores event data, including behavior data, for network node 500. In examples where network node 500 comprises a “third-party” network device, the same entity does not own or have access to both the APs or wired client-side devices and network node 500. As such, in the example where network node 500 is a third-party network device, NMS 130 does not receive, collect, or otherwise have access to the network data from network node 500.

In examples where network node 500 comprises a server, network node 500 may receive data and information, e.g., including operation related information, e.g., registration request, AAA services, DHCP requests, Simple Notification Service (SNS) look-ups, and Web page requests via receiver 520, and send data and information, e.g., including configuration information, authentication information, web page data, etc. via transmitter 522.

In examples where network node 500 comprises a wired network device, network node 500 may be connected via wired interface 502 to one or more APs or other wired client-side devices, e.g., IoT devices, within a wired network edge. For example, network node 500 may include multiple wired interfaces 502 and/or wired interface 502 may include multiple physical ports to connect to multiple APs or the other wired-client-side devices within a site via respective Ethernet cables. In some examples, each of the APs or other wired client-side devices connected to network node 500 may access the wired network via wired interface 502 of network node 500. In some examples, one or more of the APs or other wired client-side devices connected to network node 500 may each draw power from network node 500 via the respective Ethernet cable and a Power over Ethernet (PoE) port of wired interface 502.

In examples where network node 500 comprises a session-based router that employs a stateful, session-based routing scheme, network node 500 may be configured to independently perform path selection and traffic engineering. The use of session-based routing may enable network node 500 to eschew the use of a centralized controller, such as an SDN controller, to perform path selection and traffic engineering, and eschew the use of tunnels. In some examples, network node 500 may implement session-based routing as Secure Vector Routing (SVR), provided by Juniper Networks, Inc. In the case where network node 500 comprises a session-based router operating as a network gateway for a site of an enterprise network (e.g., router 187A of FIG. 1B), network node 500 may establish multiple peer paths (e.g., logical path 189 of FIG. 1B) over an underlying physical WAN (e.g., SD-WAN 177 of FIG. 1B) with one or more other session-based routers operating as network gateways for other sites of the enterprise network (e.g., router 187B of FIG. 1B). Network node 500, operating as a session-based router, may collect data at a peer path level, and report the peer path data to NMS 130.

In examples where network node 500 comprises a packet-based router, network node 500 may employ a packet- or flow-based routing scheme to forward packets according to defined network paths, e.g., established by a centralized controller that performs path selection and traffic engineering. In the case where network node 500 comprises a packet-based router operating as a network gateway for a site of an enterprise network (e.g., router 187A of FIG. 1B), network node 500 may establish multiple tunnels (e.g., logical path 189 of FIG. 1B) over an underlying physical WAN (e.g., SD-WAN 177 of FIG. 1B) with one or more other packet-based routers operating as network gateways for other sites of the enterprise network (e.g., router 187B of FIG. 1B). Network node 500, operating as a packet-based router, may collect data at a tunnel level, and the tunnel data may be retrieved by NMS 130 via an API or an open configuration protocol or the tunnel data may be reported to NMS 130 by NMS agent 544 or other module running on network node 500.

The data collected and reported by network node 500 may include periodically-reported data and event-driven data. Network node 500 is configured to collect logical path statistics via bidirectional forwarding detection (BFD) probing and data extracted from messages and/or counters at the logical path (e.g., peer path or tunnel) level. In some examples, network node 500 is configured to collect statistics and/or sample other data according to a first periodic interval, e.g., every 3 seconds, every 5 seconds, etc. Network node 500 may store the collected and sampled data as path data, e.g., in a buffer. In some examples, NMS agent 544 may periodically create a package of the statistical data according to a second periodic interval, e.g., every 3 minutes. The collected and sampled data periodically reported in the package of statistical data may be referred to herein as “oc-stats.”

In some examples, the package of statistical data may also include details about clients connected to network node 500 and the associated client sessions. NMS agent 544 may then report the package of statistical data to NMS 130 in the cloud. In other examples, NMS 130 may request, retrieve, or otherwise receive the package of statistical data from network node 500 via an API, an open configuration protocol, or another of communication protocols. The package of statistical data created by NMS agent 544 or another module of network node 500 may include a header identifying network node 500 and the statistics and data samples for each of the logical paths from network node 500. In still other examples, NMS agent 544 reports event data to NMS 130 in the cloud in response to the occurrence of certain events at network node 500 as the events happen. The event-driven data may be referred to herein as “oc-events.”

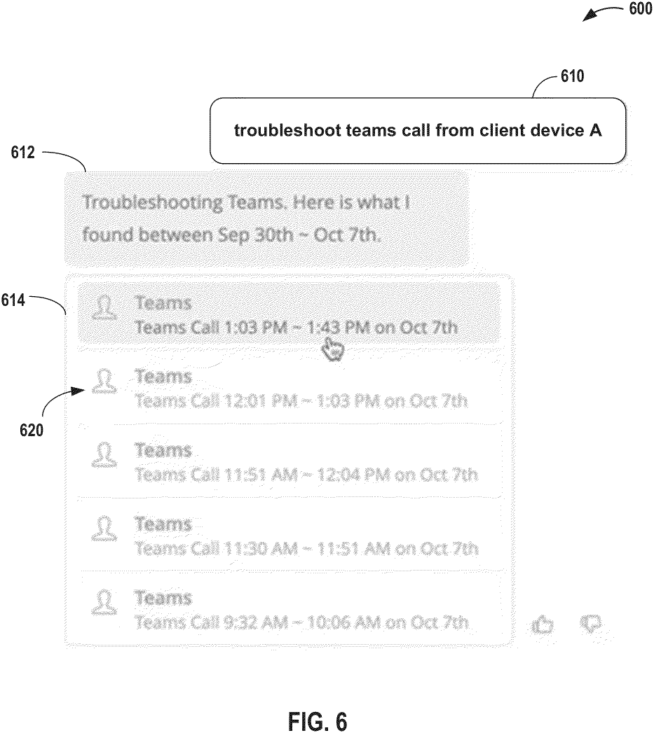

FIG. 6 illustrates a conceptual diagram of an example user interfaces of NMS 130/300 for visualization of a suggested first filter attribute, in accordance with one or more techniques of this disclosure. In the example of FIG. 6, an example conversational assistant user interface 600 includes a query or user input 610 from an administrator via admin device 111 initiating topology visualization and troubleshooting of a particular application session, and a response or output 612, 614 generated by conversational assistant engine 136, 356. In the example of FIG. 6, the user input 610 to conversational assistant user interface 600 comprises a string indicating the application and a device identifier (i.e., “troubleshoot teams call from client device A,” where “teams call” indicates the application and “client device A” comprises a client device identifier). Conversational assistant engine 136, 356 may automatically filter the application sessions of the particular network device based on the indicated application (in this example Microsoft Teams®) and a default duration (in this example the last 7 days). The response 612 within conversational assistant user interface 600 comprises a string that states “Troubleshooting Teams. Here is what I found between Sep 30^{th} ~ Oct 7^{th}.” In addition, conversational assistant user interface 600 presents output 614 as a list of all application sessions (in this example Teams calls) of the particular network device during the default duration. For example, application session 620 comprises a Teams call of the particular network device (in this example client device A) from 12:01 PM ~ 1:03 PM on Oct 7^{th}.

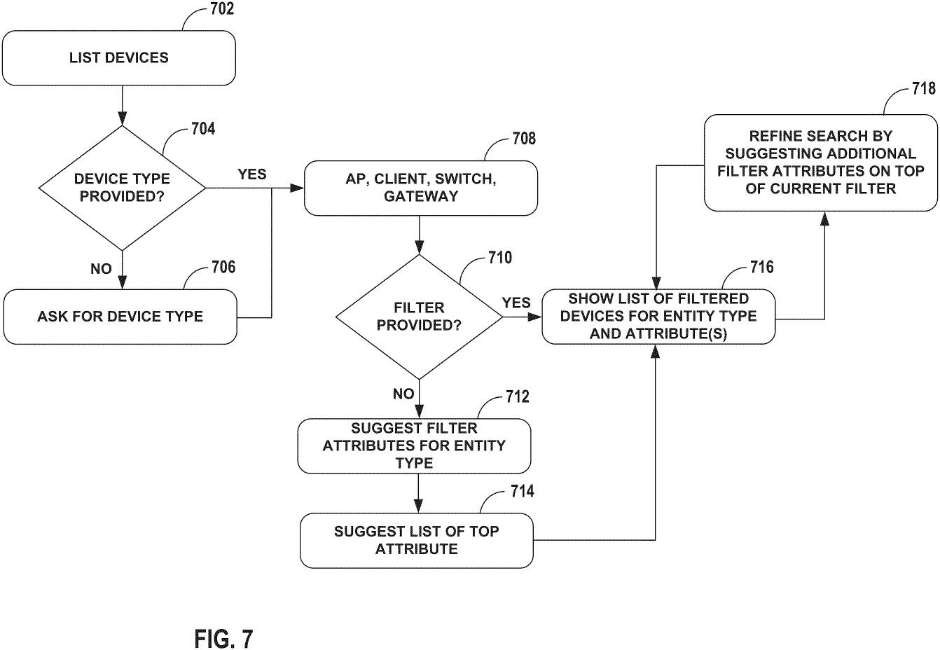

FIG. 7 illustrates a flow chart of an example process for suggesting a filter attribute, in accordance with one or more techniques of this disclosure. FIG. 7 illustrates an example workflow for reducing a resulting number of devices for an entity type that may be used to generate the suggested filter attributes for multiple different troubleshooting/search features (e.g., troubleshoot client-to-cloud, troubleshoot application, troubleshoot site, and/or entity search).

Suggested filter attribute engine 135 may determine a list of network devices (702) from the plurality of network devices based on an entity type. For example, in response to the conversational assistant engine 136 determining that the entity refers to a software application (e.g., Microsoft Teams®), suggested filter attribute engine 135 may determine a list of network devices that used the software application within a time period (e.g., a specified in the query or a preconfigured time period).

Conversational assistant engine 136 may determine whether a device type (e.g., an entity) was provided by the administrator (704). In the example of the entity search feature, an administrator may input a query “show me all APs for guest Wi-Fi.” In this example, a system (e.g., an AI engine or logical operator) may perform a fuzzy search to identify (“YES” of step 704) an entity type (e.g., a device type) as an access point (AP). Otherwise, conversational assistant engine 136 may ask for a device type (“NO” of step 704).

In response to the conversational assistant engine 136 determining the entity as, for example, an access point (AP), client device, switching device or routing device, or a gateway (708), conversational assistant engine 136 may determine if a filter is provided by the administrator (710). If no filter is provided (“NO” of step 710), conversational assistant engine 136 may suggest filter attributes for the entity type (712) and suggest a list of top attributes (714). For example, conversational assistant engine 136 may include all access points that support Wi-Fi networks with “guest” in the BSSID and/or exclude access points that exclusively support private or access-controlled Wi-Fi networks to generate a list of devices. In this example, conversational assistant engine 136 may determine suggested filter attributes to filter by providing a list of all Wi-Fi networks for the site that include the term “guest” in the BSSID from which the user may select.

Conversational assistant engine 136 may show a list of filtered devices for the entity type and attribute(s) (716). For example, upon receipt of a selection of a particular Wi-Fi network by the user, conversational assistant engine 136 may filter the list of APs to only include those APs that support the particular Wi-Fi network. If a filter is provided (“YES” of step 710), conversational assistant engine 136 may skip steps 712-714.

Conversational assistant engine 136 may optionally refine the search by suggesting one or more additional filter attributes on top of the current filter. For example, if the list of devices is still large, conversational assistant engine 136 may determine additional suggested filter attributes to filter by operating system, manufacturer or radio band (e.g., channel). For instance, conversational assistant engine 136 may identify, based on a current state of the devices, that the listed devices are configured with different operating systems. In this example, conversational assistant engine 136 may identify a suggested filter attribute to filter by operating system. Similarly, conversational assistant engine 136 may identify, based on the current state of the devices, that the listed devices are associated with different manufactures. In this example, conversational assistant engine 136 may identify a suggested filter attribute to filter by manufacturer.

In some examples, conversational assistant engine 136 may identify a suggested filter attribute based on a user profile. For example, conversational assistant engine 136 may determine that the listed devices are associated with different users or groups of users. In this example, conversational assistant engine 136 may identify a suggested filter attribute to filter by a user or group of users.

In some examples, conversational assistant engine 136 may identify a suggested filter attribute based on a current state of networking services. For example, conversational assistant engine 136 may determine that the list of devices include access points that are experiencing network issues associated with a Wi-Fi service and access points that are not experiencing network issues associated with the Wi-Fi service. In this example, conversational assistant engine 136 may suggest filtering out devices that are not experiencing network issues associated with the Wi-Fi service.

FIG. 8 illustrates a conceptual diagram of an example user interfaces of the network management system for visualization of a suggest a second filter attribute, in accordance with one or more techniques of this disclosure.

In the example of the troubleshoot application feature, VNA 133 may receive a query indicating to troubleshoot an application. For instance, in FIG. 8, VNA 133 receives a query “troubleshoot teams” (810) In this example, conversational assistant engine 136 may determine that that the entity type is “application” in response to the query indicating to troubleshoot an application and may use the attribute “client device” as an initial filter. Conversational assistant engine 136 may identify a suggested filter attribute to filter by site. For instance, conversational assistant engine 136 may identify that the listed devices using the application are configured at different sites. As shown, VNA 133 outputs “Here’s a list of top sites for application MS-Teams. Please select to continue” (812) and the selectable box that states “MIST OFFICE - MIST SITE” (814). In this example, the administrator selects mist office (814).

Conversational assistant engine 136 may determine a filtered list of client devices using the application at a particular site based on receipt of a selection of the particular site from the suggested filter attribute. For instance, VNA 133 may output, in the user interface, an indication of the top client devices using the application MS-TEAMS at the site “Mist Office.” As shown, VNA 133 outputs “Here’s a list of top users at site MIST OFFICE for application MS-Teams. Please select to continue” (818) and the selectable box that states “USER 1” (820) and “USER 2” (822).

In this way, VNA 133 may suggest filter attribute(s) that are intuitive to the administrator for helping to filter or further filter the list of devices, which may help to reduce an amount of time a network issue occurs and/or reduce an amount of time an administrator spends troubleshooting a network.

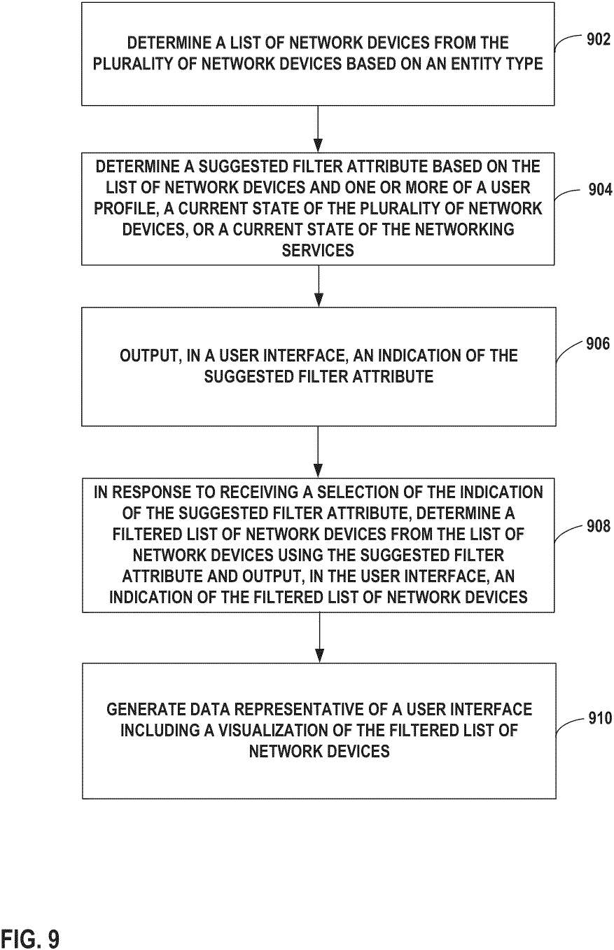

FIG. 9 is a flow chart illustrating an example operation of suggesting a filter attribute, in accordance with one or more techniques of the disclosure. FIG. 9 is discussed with FIGS. 1-8 for example purposes only. NMS 130 may determine a list of network devices from the plurality of network devices based on an entity type (902). For example, in response to the conversational assistant engine 136 determining that the entity refers to a software application (e.g., Microsoft Teams®), suggested filter attribute engine 135 may determine a list of network devices that used the software application within a time period (e.g., a specified in the query or a preconfigured time period). In some example, in response to the conversational assistant engine 136 determining that the entity refers to an access point, suggested filter attribute engine 135 may determine a list of network devices that are access points and exclude other devices (e.g., gateway devices, client devices, routing devices, and/or switching devices).

NMS 130 may determine a suggested filter attribute based on the list of network devices and one or more of a user profile, the current state of the plurality of network devices, or a current state of the networking services (904). For example, suggested filter attribute engine 135 may determine the suggested filter attribute for one or more sites of the plurality of sites based on a usage of the application. For instance, suggested filter attribute engine 135 may determine, based on a user profile stored in network data 137, that a user associated with the query is assigned a set of sites. In this instance, suggested filter attribute engine 135 may determine one or more sites from the set of sites based on a respective usage of the application at each site of the set of sites. For instance, suggested filter attribute engine 135 may omit sites from the set of sites that have no usage of the application or have a usage of the application that is less than a threshold.

NMS 130 may output, in a user interface, an indication of the suggested filter attribute (906). For example, conversational assistant engine 136 may generate data representative of a user interface for presentation on an administrator device. The user interface may include a visualization of the suggested filter attribute (see FIG. 8). The visualization may include color-coding, icons, or other indicia of the suggested filter attribute.

In response to receiving user input representative of a selection of the indication of the suggested filter attribute, NMS 130 may determine a filtered list of network devices from the list of network devices using the suggested filter attribute and output, in the user interface, an indication of the filtered list of network devices (908). For example, suggested filter attribute engine 135 may further filter the network devices from the list of network devices to the filtered list of network devices using the suggested filter attribute (e.g., a specific site). NMS 130 may generate data representative of a user interface including a visualization of the filtered list of network devices (910). For example, conversational assistant engine 136 may generate data representative of a user interface for presentation on an administrator device. The user interface may include a visualization of the filtered list of network devices. In some examples, suggested filter attribute engine 135 may redirect the user to a customer insight or recommended action user interface specific to one or more network device of the filtered list of network devices.

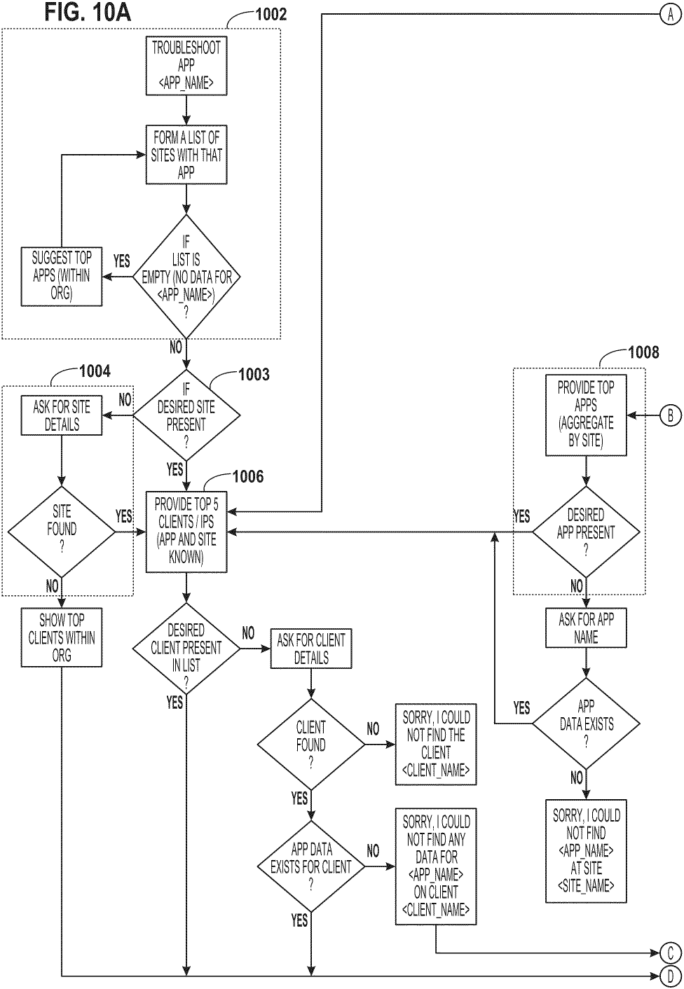

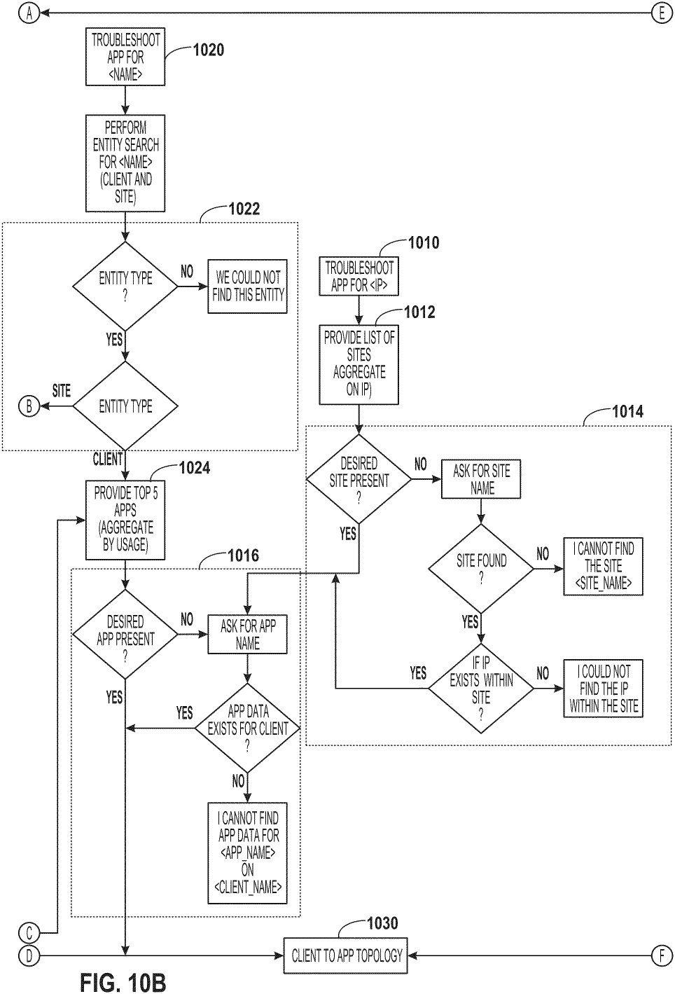

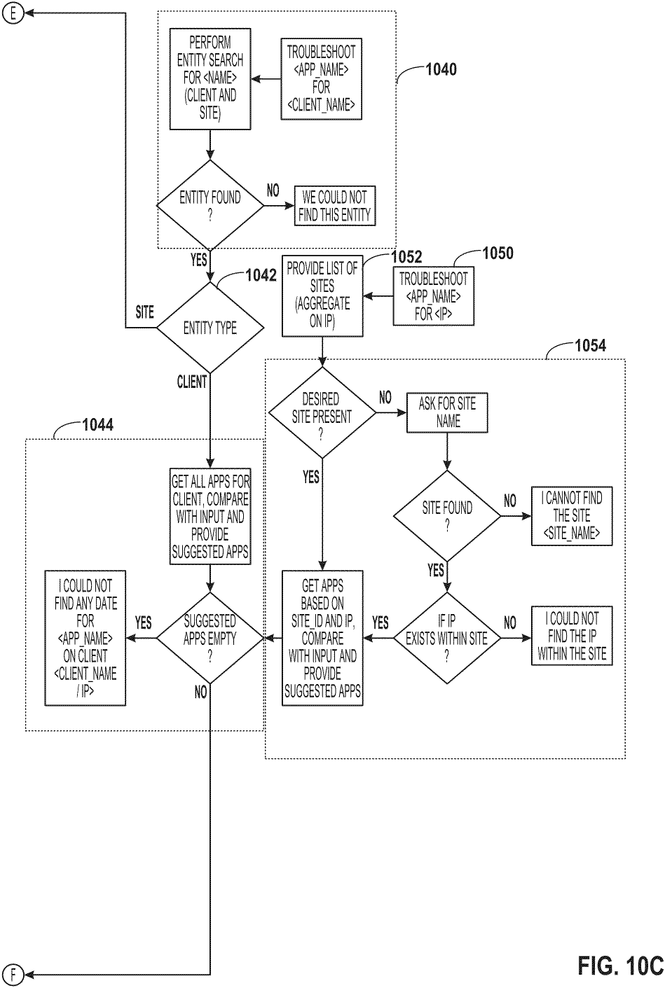

FIGS. 10A-10C is a flow chart illustrating an example workflow for suggesting a filter attribute, in accordance with one or more techniques of the disclosure. In FIG. 10A, conversational assistant engine 136 may receive an indication of an application name and determine a specific application as the entity (1002). In this example, suggested filter attribute engine 135 may determine a suggested filter attribute for one or more sites (1004). If a site is not found (NO of step 1004), conversational assistant engine 136 may show top clients and output applications for a selected client device to step 1030 in FIG. 10B. Conversational assistant engine 136 may determine if the desired site is present (1003).

If a site is found (YES of step 1004), suggested filter attribute engine 135 may determine a suggested filter attribute for one or more client devices (1006). For example, suggested filter attribute engine 135 may determine an ordered list of the one or more client devices based on the respective usage of the application at each client device of the set of client devices. For instance, suggested filter attribute engine 135 may show a first client device with a highest usage of a particular application at a first position (e.g., top) of the ordered list, followed by a second client device with a second highest usage of a particular application at a second of the ordered list, and so on. Conversational assistant engine 136 may show the top client and IPS and output applications for a selected client device to step 1030. If a site is not found (NO of step 1004), suggested filter attribute engine 135 may ask for site details and show top client devices within the organization. In this example, suggested filter attribute engine 135 may output applications for a selected client device to step 1030. In examples where an administrator provides the application and site (1008), conversational assistant engine 136 may verify that the application is present in a listing of top applications by the site and, if not ask the administrator for the application name, and the process proceeds to step 1006.

In FIG. 10B, conversational assistant engine 136 may receive an indication of an application name and IP address and determine a specific client or site as the entity (1010). Suggested filter attribute engine 135 may determine a suggested filter attribute for one or more sites (1012). In this example, conversational assistant engine 136 may prompt to identify a specific client device having the IP address within the site selected by an administrator (1014). Conversational assistant engine 136 may ask for an application name and output one or more applications determined from the application name for the specific client device to step 1030 (1016).

Conversational assistant engine 136 may receive an indication of an application name and name (1020). Conversational assistant engine 136 may determine that the name corresponds to a site and the process continues to step 1008 of FIG. 10A (SITE of step 1022). Conversational assistant engine 136 may determine that the name corresponds to a client device (CLIENT of step 1022). In this example, suggested filter attribute engine 135 may determine a suggested filter attribute for one or more sites (1024). For example, suggested filter attribute engine 135 may generate the one or more sites in a ranked list by usage of the application (e.g., aggregate by usage). In this example, conversational assistant engine 136 may proceed with step 1016.

Once the client device and application are identified, VNA 133 may troubleshoot using a client to application topology 1030. Additional information with respect to client-to-cloud troubleshooting is described in U.S. Pat. Application No. 17/935,704, filed 27 Sep. 2022, the entire contents of which is incorporated herein by reference.

In FIG. 10C, conversational assistant engine 136 may receive an indication of a client and site and determine a specific application as the entity (1040). Conversational assistant engine 136 may determine that the name corresponds to a site and the process continues to step 1006 of FIG. 10A (SITE of step 1042). Conversational assistant engine 136 may determine that the name corresponds to a client device (CLIENT of step 1042) and outputs applications for the client device to step 1030 of FIG. 10B (1044).

Conversational assistant engine 136 may receive an indication of an application name and IP address (1050). Suggested filter attribute engine 135 may determine a suggested filter attribute for one or more sites using the IP address (1052). In this example, conversational assistant engine 136 may optionally prompt to identify a specific site (1054) and proceed to step 1044.

The techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such as a processor or an integrated circuit device, such as an integrated circuit chip or chipset. Alternatively, or additionally, if implemented in software or firmware, the techniques may be realized at least in part by a computer-readable data storage medium comprising instructions that, when executed, cause a processor to perform one or more of the methods described above. For example, the computer-readable data storage medium may store such instructions for execution by a processor.

A computer-readable medium may form part of a computer program product, which may include packaging materials. A computer-readable medium may comprise a computer data storage medium such as random-access memory (RAM), read-only memory (ROM), non-volatile random-access memory (NVRAM), electrically erasable programmable read-only memory (EEPROM), Flash memory, magnetic or optical data storage media, and the like. In some examples, an article of manufacture may comprise one or more computer-readable storage media.

In some examples, the computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

The code or instructions may be software and/or firmware executed by processing circuitry including one or more processors, such as one or more digital signal processors (DSPs), general purpose microprocessors, application-specific integrated circuits (ASICs), field-programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, functionality described in this disclosure may be provided within software modules or hardware modules.

What is claimed is:

1. A network management system (NMS) that manages a plurality of network devices configured to provide networking services at a plurality of sites, the NMS comprising:
a memory storing a current state of the plurality of network devices; and
one or more processors coupled to the memory and configured to:
determine a list of network devices from the plurality of network devices based on an entity type;
determine a suggested filter attribute based on the list of network devices and one or more of a user profile, the current state of the plurality of network devices, or a current state of the networking services;
output, in a user interface, an indication of the suggested filter attribute; and
in response to receiving user input representative of a selection of the indication of the suggested filter attribute, determine a filtered list of network devices from the list of network devices using the suggested filter attribute and output, in the user interface, an indication of the filtered list of network devices.

2. The NMS of claim 1, wherein the one or more processors are further configured to generate data representative of the user interface for presentation on an administrator device, the user interface including a visualization of the filtered list of network devices.

3. The NMS of claim 1, wherein the one or more processors are further configured to:
receive a query indicating an application; and
determine the entity type as a client device based on the query indicating the application,
wherein, to determine the suggested filter attribute, the one or processors are configured to determine the suggested filter attribute for one or more sites of the plurality of sites based on a usage of the application.

4. The NMS of claim 3, wherein, to determine the suggested filter attribute, the one or more processors are further configured to:
determine a set of sites from the plurality of sites based on the user profile; and
determine the one or more sites from the set of sites based on a respective usage of the application at each site of the set of sites.

5. The NMS of claim 1, wherein the one or more processors are further configured to:
receive a query indicating an application; and
determine the entity type as a client device based on the query indicating the application,
wherein, to determine the suggested filter attribute, the one or processors are configured to determine the suggested filter attribute for one or more client devices based on a usage of the application.

6. The NMS of claim 5, wherein, to determine the suggested filter attribute, the one or more processors are further configured to:
determine a set of client devices from the list of network devices based on the user profile; and
determine one or more client devices from the set of client devices based on a respective usage of the application at each client device of the set of client devices.

7. The NMS of claim 6, wherein the one or more processors are further configured to:
determine an ordered list of the one or more client devices based on the respective usage of the application at each client device of the set of client devices,
wherein, to output the indication of the suggested filter attribute, the one or more processors are configured to output an indication of the ordered list of the one or more client devices.

8. The NMS of claim 1, wherein the one or more processors are further configured to:
receive a query indicating an entity search; and
determine the entity type based on the query indicating the entity type,
wherein, to determine the suggested filter attribute, the one or processors are configured to determine the suggested filter attribute for one or more of a wireless network, an operating system, a manufacturer, a user, an operational states of the entity type, or one or more radio bands.

9. The NMS of claim 1, wherein the one or more processors are further configured to:
determine the entity type comprises an access point, a network switch, or a gateway,
wherein, to determine the suggested filter attribute, the one or processors are configured to determine, based on the current state of the networking services, the suggested filter for one or more services of the networking services.

10. A method for managing a plurality of network devices configured to provide networking services at a plurality of sites, the method comprising:
determining, by one or more processors, a list of network devices from the plurality of network devices based on an entity type;
determining, by the one or more processors, a suggested filter attribute based on the list of network devices and one or more of a user profile, the current state of the plurality of network devices, or a current state of the networking services;
outputting, by the one or more processors, in a user interface, an indication of the suggested filter attribute; and
in response to receiving user input representative of a selection of the indication of the suggested filter attribute, determining, by the one or more processors, a filtered list of network devices from the list of network devices using the suggested filter attribute and output, in the user interface, an indication of the filtered list of network devices.

11. The method of claim 10, further comprising:
generating, by the one or more processors, data representative of the user interface for presentation on an administrator device, the user interface including a visualization of the filtered list of network devices.

12. The method of claim 10, further comprising:
receiving, by the one or more processors, a query indicating an application; and
determining, by the one or more processors, the entity type as a client device based on the query indicating the application,
wherein determining the suggested filter attribute comprises determining the suggested filter attribute for one or more sites of the plurality of sites based on a usage of the application.

13. The method of claim 12, wherein determining the suggested filter attribute comprises:
determining a set of sites from the plurality of sites based on the user profile; and
determining the one or more sites from the set of sites based on a respective usage of the application at each site of the set of sites.

14. The method of claim 10, further comprising:
receiving, by the one or more processors, a query indicating an application; and
determining, by the one or more processors, the entity type as a client device based on the query indicating the application,
wherein determining the suggested filter attribute comprises determining the suggested filter attribute for one or more client devices based on a usage of the application.

15. The method of claim 14, wherein determining the suggested filter attribute comprises:
determining a set of client devices from the list of network devices based on the user profile; and
determining one or more client devices from the set of client devices based on a respective usage of the application at each client device of the set of client devices.

16. The method of claim 15, further comprising:
determining, by the one or more processors, an ordered list of the one or more client devices based on the respective usage of the application at each client device of the set of client devices,
wherein outputting the indication of the suggested filter attribute comprises outputting an indication of the ordered list of the one or more client devices.

17. The method of claim 10, further comprising:
receiving, by the one or more processors, a query indicating an entity search; and
determining, by the one or more processors, the entity type based on the query indicating the entity type,
wherein determining the suggested filter attribute comprises determining the suggested filter attribute for one or more of a wireless network, an operating system, a manufacturer, a user, an operational states of the entity type, or one or more radio bands.

18. The method of claim 10, further comprising:
determining, by the one or more processors, the entity type comprises an access point, a network switch, or a gateway,
wherein determining the suggested filter attribute comprises determining, based on the current state of the networking services, the suggested filter for one or more services of the networking services.

19. A computer-readable storage medium comprising instructions that, when executed, cause one or more processors of a network management system to:
determine a list of network devices from a plurality of network devices based on an entity type;
determine a suggested filter attribute based on the list of network devices and one or more of a user profile, the current state of the plurality of network devices, or a current state of networking services provided by the plurality of network devices;
output, in a user interface, an indication of the suggested filter attribute; and
in response to receiving user input representative of a selection of the indication of the suggested filter attribute, determine a filtered list of network devices from the list of network devices using the suggested filter attribute and output, in the user interface, an indication of the filtered list of network devices.

20. The computer-readable storage medium of claim 19, comprising instructions that, when executed, cause one or more processors of a network management system to generate data representative of the user interface for presentation on an administrator device, the user interface including a visualization of the filtered list of network devices.
